(19) United States
(12) Patent Application Publication
(10) Pub. No.: US 2020/0077783 A1
(43) Pub. Date: Mar. 12, 2020

(54) CAVITATION BASED CLEANING

(71) Applicant: Ted BRACKETT, Noosaville (AU)

(72) Inventor: Ted BRACKETT, Noosaville (AU)

(21) Appl. No.: 16/687,224

(22) Filed: Nov. 18, 2019

Related U.S. Application Data
(62) Division of application No. 16/261,963, filed on Jan. 30, 2019.
(60) Provisional application No. 62/626,632, filed on Feb. 5, 2018.

(51) Int. Cl. A46B 17/06; C02F 1/34; B08B 3/10; B44D 3/00

(52) U.S. Cl. CPC A46B 17/06; C02F 1/34; A46B 2200/202; B44D 3/006; B08B 3/10

(57) ABSTRACT

The novel cavitation based cleaning devices preferably contain one or more cavitation creating elements and a reservoir holding the cavitation creating elements with an opening for introduction of an item in proximity to the cavitation creating elements. The reservoir may be or include a water filled reservoir. Collapse of bubbles created by the cavitation creating elements preferably pulls debris from the item. In some aspects, the reservoir is configured to permit introduction of an item comprising a paint brush. The debris may include wet, semi-dry, and/or dry paint on and/or inside the paint brush. The cavitation creating elements may include cylinders that spin in opposite directions within the reservoir. Cavitation is preferably created without using transonic methods or elements. Aspects of the invention also include methods performed by and/or using the novel cavitation based cleaning devices disclosed herein.

### CROSS-REFERENCE TO RELATED APPLICATION

The present application claims benefit of and priority to U.S. patent application Ser. No. 16/261,963 filed on Jan. 30, 2019, which in turn claims benefit and priority to U.S. Patent Application Ser. No. 62/626,632 filed on Feb. 5, 2018. These applications are incorporated by reference as if fully set forth herein.

### BACKGROUND

The present disclosure generally relates to cavitation-based cleaning, for example to clean paint brushes.

### SUMMARY

One exemplary embodiment of the disclosed subject matter is a cleaning device including one or more cavitation creating elements and a reservoir holding the cavitation creating elements with an opening for introduction of an item in proximity to the cavitation creating elements. The reservoir may be or include a water filled reservoir. Collapse of bubbles created by the cavitation creating elements preferably pulls debris from the item.

In some aspects, the reservoir is configured to permit introduction of an item comprising a paint brush. The debris may include wet, semi-dry, and/or dry paint on and/or inside the paint brush.

The cavitation creating elements may include cylinders that spin in opposite directions within the reservoir. The cylinders' speeds are equal in some aspects by virtue of at least one connecting element, for example one or more gears. Cavitation may be created without using transonic methods or elements.

Other exemplary embodiments of the disclosed subject matter include methods performed by and/or using the novel cavitation based cleaning device(s) disclosed herein.

This brief summary has been provided so that the nature of the invention may be understood quickly. Additional elements and/or different elements than those set forth in this summary may be used. A more complete understanding of the invention may be obtained by reference to the following description in connection with the attached drawings.

### BRIEF DESCRIPTION OF THE DRAWINGS

Some non-limiting exemplary embodiments of the disclosed subject matter are illustrated in the following drawings. Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described. Dimensions of components and features shown in the figures are chosen for convenience or clarity of presentation. For convenience or clarity, some elements or structures are not shown or shown only partially and/or with different perspective or from different point of views.

FIG. 1 illustrates a cavitation bubble collapsing and thereby capturing a particle of debris according to aspects of the subject technology.

FIG. 2 illustrates cavitation bubbles cleaning an item according to aspects of the subject technology.

FIG. 3 illustrates an example of a device using cavitation bubbles to clean a brush according to aspects of the subject technology.

FIG. 4 illustrates an example of a device including rollers used to create cavitation bubbles for cleaning an item according to aspects of the subject technology.

### DETAILED DESCRIPTION

U.S. Provisional Patent Application Ser. No. 62/626,632 entitled “CAVITATION BASED CLEANING” and filed on Feb. 5, 2018 including its Appendix is incorporated by reference as if fully set forth herein.

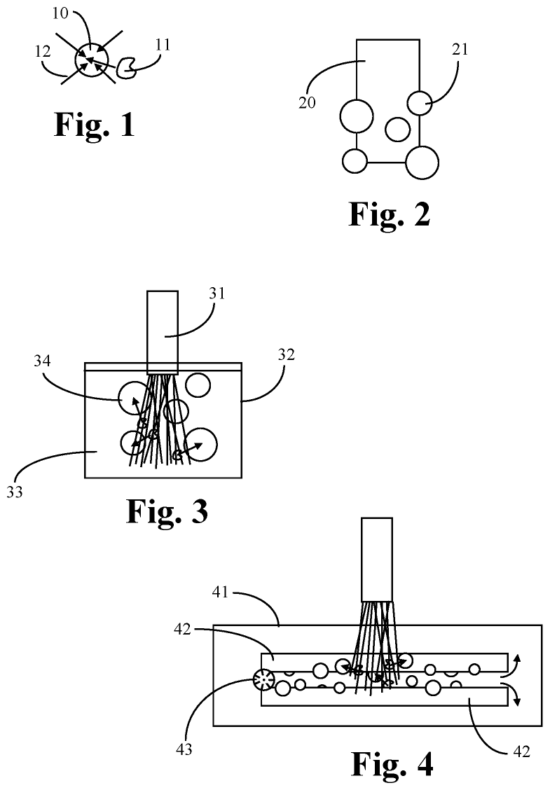

FIG. 1 illustrates a cavitation bubble collapsing and thereby capturing a particle of debris according to aspects of the subject technology. A cavitation bubble is a tiny pocket of vacuum or near vacuum when an item moves with sufficient speed and/or in a particular manner in a fluid. For example, propellers create cavitation bubbles with moving sufficiently fast in water. A cavitation bubble may be created in other ways and/or using other devices, for example as described below.

Cavitation bubbles are short-lived and collapse. When a cavitation bubbles collapses, it tends to pull surrounding particles toward where the bubble previously existed. This process is illustrated in FIG. 1, which shows cavitation bubble 10 collapsing particle 11. The collapse is illustrated by arrows 12. Cavitation effect may be created through various processes including but not limited to air injection, fluid injection, mechanical devices, electromagnetic devices, and other processes and devices. While the illustration in FIG. 1 is with respect to a particle, such collapse may pull non-particle debris such as liquid droplets, biological matter such as viruses or bacteria, and/or or the like.

FIG. 2 illustrates cavitation bubbles cleaning an item according to aspects of the subject technology. Item 20 is placed or otherwise positioned in proximity to cavitation bubbles 21. When the cavitation bubbles collapse, they clean the item.

FIG. 3 illustrates an example of a device using cavitation bubbles to clean a brush according to aspects of the subject technology. Other items besides brushes may be cleaned. As seen there, brush 31 is shown inserted into reservoir 32 with a space holding working fluid 33 such as water. Reservoir 32 is configured to permit introduction of an item such as brush 31, for example by being properly sized and shaped with a suitable opening. One possible shape is a generally oval shape, although other shapes may be used. Cavitation bubbles 34 are shown cleaning brush 31.

Working fluid 33 may include additional materials, for example detergent, paint thinner, other cleaning agents, and/or other substances. However, cleaning via cavitation according to aspects of the subject technology may be performed without such additional materials. The ability to clean without use of chemicals may be important for some applications of the subject technology, for example but not limited to use with items for food preparation, medical applications, and certain industrial applications where such chemicals could present hazards and/or interfere with other processes.

FIG. 4 illustrates an example of a device including rollers used to create cavitation bubbles for cleaning an item according to aspects of the subject technology. Reservoir 41 preferably filled with a working fluid such as water includes cylinders 42. While two cylinders are depicted, any number of cylinders may be used. The surface of the cylinders may be smooth, bumpy, brush-like, or featured in other manners.

The cylinders preferably may be driven by a motor, air, or in any other manner to spin at sufficient speed(s) to create cavitation bubbles. In some aspects the cylinders move in opposite directions. The cylinders' speeds preferably are equal by virtue of at least one connecting element, for example a gear or other mechanical interlink. The arrangement depicted in FIG. 4 preferably creates cavitation in a non-ultrasonic manner. The fluid dynamics/hydrodynamics at work is a result of submerged rotating/moving elements, which create “liquid cavitating jets” and the cavitation by-product cleaning bubbles.

In some exemplary embodiments, cylinders 42 move in opposite directions simultaneously, for example clock-wise and counter-clockwise. As the cylinders reach sufficient speed, for example 800-1,000 RPM, the cylinders may create a “Dual Coriolis Effect.” A possible by-product of this effect is the formation of “cavitation bands” or “cavitation clouds” formed of cavitation bubbles. The collapse of the bubbles forming these bands or clouds may result in shock waves that pass over and/or through the item and thereby clean the item. This effect may occur and continually repeat in milliseconds until the cylinders stop spinning.

Growth of the bubbles may also be very rapid, sometimes termed as “explosive.” This growth by itself may also facilitate cleaning of the item by applying shear forces to effectively “blast” debris from an item. This explosive growth and resulting forces may be sufficiently strong to clean the item and/or assist cleaning of the item by collapse of the cavitation bubbles.

Cavitation bubbles and/or effects may be created and used to clean items through devices and/or techniques other than those described above. For example and without limitation, cavitation bubbles may be created using air and/or fluid injection, alone or in combination with some or all of the above.

While certain embodiments have been described, the embodiments have been presented by way of example only and are not intended to limit the scope of the invention. Indeed, the cavitation based cleaning devices and methods of use disclosed herein may be embodied in a variety of other forms. Furthermore, various omissions, substitutions, and changes in the form of the disclosed elements may be made without departing from the spirit of the invention.

1. A method of cleaning an item comprising:
creating cavitation in a space; and
introducing the item into the space, wherein the cavitation cleans the item, and wherein the cavitation is created without using transonic methods or elements.

2. A method as in claim 1, wherein the space comprises a water filled reservoir.

3. A method as in claim 2, wherein collapse of bubbles created by the cavitation pulls debris from the item.

4. A method as in claim 3, wherein the item comprises a paint brush.

5. A method as in claim 4, wherein the debris comprises wet, semi-dry, and/or dry paint on and/or inside the paint brush.

6. A method as in claim 1, wherein the step of creating the cavitation comprises spinning cylinders in opposite directions within the space.

7. A method as in claim 6, wherein the cylinders' speeds are equal by virtue of at least one connecting element.

8. A method as in claim 7, wherein the connecting element comprises a gear.
